(19) United States
(12) Patent Application Publication
(10) Pub. No.: US 2017/0134810 A1
(43) Pub. Date: May 11, 2017

(54) SYSTEMS AND METHODS FOR USER INTERACTION

(71) Applicant: Didja, Mountain View, CA (US)

(72) Inventors: Ashwin Kashyap, Mountain View, CA (US); Rajiv Chamraj, Cupertino, CA (US); Douglas Warren, Redwood City, CA (US)

(21) Appl. No.: 14/936,675

(22) Filed: Nov. 9, 2015

(51) Int. Cl. H04N 21/4788; H04N 21/44; H04N 21/414; H04N 21/45; H04N 21/81; G11B 27/031; H04N 21/8549; H04N 21/439

(52) U.S. Cl. CPC H04N 21/4788; H04N 21/8549; H04N 21/44008; H04N 21/4394; H04N 21/4532; H04N 21/8133; G11B 27/031; H04N 21/41407

(57) ABSTRACT

Systems and methods for streaming video, interacting with video content, and sharing video content are disclosed herein. Other embodiments are also disclosed herein.

### RELATED APPLICATION(S)

The present application is a continuation of U.S. patent application Ser. No. 13/684,162, entitled “Systems and Methods for User Interaction,” filed on Nov. 22, 2012, which claims priority from U.S. Provisional Patent Application No. 61/563,065, entitled “Systems and Methods for User Interaction,” filed on Nov. 23, 2011; and U.S. Provisional Patent Application No. 61/622,534, entitled “Systems and Methods for User Interaction,” filed on Apr. 11, 2012, each of which is incorporated by reference in their entireties.

### FIELD OF THE INVENTION

The present invention relates to systems and methods for user interaction. One embodiment allows a user to interact with other individuals using data from an event.

### BRIEF DESCRIPTION OF THE DRAWINGS

To facilitate further description of the embodiments, the following drawings are provided. The same reference numerals in different figures denote the same elements.

FIG. 1 illustrates a block diagram of an example of a system for streaming content, according to an embodiment.

FIG. 2 illustrates a block diagram of an example of a system for streaming content, according to an embodiment.

FIG. 3 illustrates a flow chart of an example of a method of detecting video content, according to an embodiment.

FIG. 4 illustrates examples of audio and video signals and examples of the types of information that those respective signals can contain.

FIG. 5 illustrates a flow chart of an example of a method of interacting with content clips, according to an embodiment.

FIG. 6 illustrates a flow chart of an example of a method of collecting event and/or interaction data, according to an embodiment.

FIG. 7 illustrates a flow chart of an example of a method of recommending content, according to an embodiment.

FIG. 8 illustrates a flow chart of an example of a method of creating clips, according to an embodiment.

FIG. 9 illustrates a block diagram of a system for creating an automated playlist, according to an embodiment.

FIG. 10 illustrates an example of screen shot of a mobile device displaying one or methods according to an embodiment.

FIG. 11 illustrates an example of screen shot of a mobile device displaying one or methods according to an embodiment.

FIG. 12 illustrates an example of screen shot of a mobile device displaying one or methods according to an embodiment.

FIG. 13 illustrates an example of screen shot of a mobile device displaying one or methods according to an embodiment.

FIG. 14 illustrates an example of screen shot of a mobile device displaying one or methods according to an embodiment.

### DETAILED DESCRIPTION

In some embodiments of the present invention, systems and methods of interacting with an event are disclosed. In the same or other embodiments, the systems and methods include providing a way for users to interact with others as it relates to an event. In the same or other embodiments, the systems and methods allow users to receive video clips of an event. The clips can then be used to interact with other individuals.

According to embodiments of the present invention, a user can use a device, such as, for example, a mobile phone, a tablet device, a computer, or a custom designed device, to indicate that he is watching a particular event. The event can comprise, for example, a television program, a movie, streaming video content, a live event (e.g., a sporting event, a concert, a play, etc.). The device can then be used to determine what event the user is watching. For example, the audio of a television program can be used to determine what program is being watched, and even what channel is being watched. In other examples, GPS can be used to determine that the user is at a particular sporting venue in which a sporting event is taking place.

According to embodiments of the present invention, once the device has been used to determine what event the user is watching (with possible help from a backend server), data concerning the event can be presented to the user via the device. For example, for a television program, the title, channel, actors, and other information can be given to the user. In addition, video clips of the television program can be presented to the user. Multiple clips can be presented each a certain length in time, thereby allowing the user to choose a particular clip of interest.

In addition, in some embodiments, if the user is at a live event, such as, for example, a sporting event that is detected, and that event is being broadcast, the user can receive video clips of the broadcast of that event once it is detected.

In the same or other examples, the data about the event can include information about the scene of television program. For example, the data can include the designer of the dress that a character in a television program is wearing, where a person can buy that dress, the cost of the dress, coupons for the dress, and the like. It should be noted that any possible information about an event can be provided to the user.

According to embodiments of the present invention, the user can select the data presented, such as, for example, one of the video clips, and interact with others. For example, the user can send the video clip to other individuals via MMS text, social network (e.g., Facebook, Twitter, etc.), and the like. In addition, the user can also include comments with the deliverable data.

In the same or other embodiments of the present invention, the systems and methods can include providing a suggestion to a user of what would be interesting to watch, or what programs are being watched. In some embodiments, the systems and methods disclosed herein use what is trending (for example, what is trending on twitter or other social networks) to determine what is being watched. In the same or other embodiments, the systems and methods disclosed herein use what a users contacts are watching to determine what is being watched. It should be noted that other methods for determining what is being watched not specifically described herein can be used.

According to embodiments of the present invention, the user may record comments in sync with the original video clip. In some embodiments, the user presses a “record” button while previewing the selected video clip. When the button is pressed, audio is recorded and sent to the web server for sharing. In the same or other embodiments, the original audio is mixed with the commentary audio on the server side of the system, unless the content delivery network (CDN) is incapable of supporting the server side mixing of audio, in which case, the system will resort to client side audio mixing.

Some embodiments of the present invention allow a user to do “audio search”, wherein the user captures a snippet of audio of a TV program. In the same or other embodiments, an audio fingerprinting and indexing system can match the audio query to a corresponding program, such as, for example, a television program. The audio search technology can be deployed on consumer devices such as, for example, tablets, mobile phones, set-top-boxes, or computers.

In one example, the current system captures up to twenty seconds of audio samples when determining the correct program. In other examples the system can use audio samples of greater than twenty second or less than twenty seconds when determining the correct program.

The function of the audio fingerprint module is to process chunks of audio (in one embodiment, seven seconds of audio, although it should be noted that this can be greater than seven seconds or less than seven seconds in other embodiments). The audio is then processed to generate a compact fingerprint that can uniquely represent the audio. In some examples, the audio is processed using fast fourier transform and other audio processing algorithms. In some embodiments, the fingerprint is a list of integers. In the same or other embodiments, the number of such integers generated ranges of approximately 30-50 per second of audio. In some embodiments, the number of such integers ranged less than approximately 30 per second of audio. In other embodiments, the number of such integers ranged greater than approximately 50 per second of audio. In some embodiments of the present invention, a total of approximately 20 seconds of audio is captured to determine the matching program. It should be noted that more than or less than 20 seconds of audio can be used.

In some embodiments, the core fingerprint extraction algorithms run both on the frontend as well as the backend.

The front end component is typically run on consumer devices such as, for example, mobile phones, tablets, internet-enabled set-top-boxes, or computers. These components comprise an audio fingerprint extraction module. The audio fingerprint module needs audio data (for example, up to 20 seconds of audio) to be captured, before it can be processed and the corresponding program can be matched.

Once these fingerprints are generated, the device sends a suitably encoded version of the list of integers to the backend server. The server is able to efficiently determine the TV show that is the closest match to the given query and responds with this information which is encoded suitably. In some embodiments the JavaScript Object Notation (JSON) format is used to encode the information for transfer between the client device and the database. In the same or other embodiments, the encoded information is communicated to the backend server by means of a Remote Procedure Call (RPC) mechanism. In the same or other embodiments, the RPC mechanism comprises a JSON-encoded message delivered via the HTTP protocol. In the same or other embodiments, the backend system decodes the JSON-encoded message, retrieves the corresponding clips, and sends a JSON-encoded response message back to the client device.

As outlined above, the fingerprinting module processes, for example, 7 second chunks of audio and returns a list of integers that uniquely represent the audio. The indexer builds an inverted index out of these lists of integers. In other words, for each fingerprint integer, a list of audio files that contain this fingerprint is associated. When a query is presented to the server, it looks up all the audio files that contain this list of fingerprints and calculates a frequency score for every audio file containing the matching integers. It should be noted that the fingerprinting module processes can comprise further procedures not specifically mentioned herein.

In some embodiments of the present invention, a process background matching is employed. The steps involved are as follows:
1. The app captures microphone input periodically and does a fingerprint match as explained earlier. This is done every 30-60 seconds and is not user initiated and not necessarily user visible. It should be noted that less than 30 seconds or more than 60 seconds can be used.
2. The outcome of this lookup could be one of:
   a. Single Real match with a certain confidence score
   b. Multiple matches with multiple confidence scores.
   c. False positive matches with a confidence scores
   d. No match (and no score)
3. A history of the results is maintained. When a user clicks on a particular result, the system remembers this. For example, if the server returns [“ABC”, “KPIX”, “ESPN”] as possible matches but the user selects “ESPN” even though the confidence score was lower, we give preference to the user's selection by means of linearly combining the result score with the user's preference as follows: (0.5*score+0.5*1.0). Where the 1.0 score signifies the user selected a particular result hence a bias towards that particular result.
4. On subsequent lookups, if the same program/channel is returned, the history result is updated by linearly combining the old score and the new. The importance of the old score is diminished so that when the user switches the channel/program the event is able to be determined. At the same time, it is preferable to avoid detecting a false positive match as a legitimate match. In general, the score is updated as follows: (alpha*old_score+(1−alpha)*new_score). These parameters need to be selected intelligently and tuned appropriately. Notice that if a false positive match is not subsequently returned, the new_score is zero and the final score gradually reaches 0.
5. When the user taps on “Automatically detect”, a list of matches is selected that have the highest score and display the results sorted by respective scores.

In some embodiments the Closed Captioning data is extracted by means of an EIA-608 decoder (commonly known as line 21). In the same or other embodiments, after the raw text is extracted, the text is further processed in order to identify named-entities, such as, for example, brands, celebrities, places, etc. In some embodiments errors in the Closed Captioning are corrected by natural language processing techniques.

In some embodiments, a database of objects with corresponding metadata is available. The objects in the database represent ads to be shown, coupons, ads for related shows, or poll questions, for example. Each object's metadata describes properties of the object, such as the category of the ads.

The process of creating this metadata could be manual or automated, and in some embodiments, each of the metadata items is assigned a unique integer. In addition, this database could be populated manually based on sales or in more automatic manner such as by using coupon search engines or ad exchanges.

The metadata of each of the object can be represented in the standard vector space model as follows:

dj=(w1,j,w2,j, . . . , wt,j)

Where,

d is the object/document in question;

j is the jth object in the database;

w represents the category or term. It is assumed, each category has a unique I.D.;

t is the total number of categories.

In order to show relevant ads to the user, it may be desirable to understand the topics and categories that a particular user is interested in. This process is generally referred to as behavioral profiling and can be accomplished using a plethora of means including the use of tracking cookies. In one embodiment, this profile can be represented in the standard vector space as follows:

q=(w1,q,w2,q, . . . , wt,q)

Where,

q represents the user's profile;

w represents the category as already explained above.

It should be noted that the user's profile evolves and changes over time based on how the user consumes and interacts information. In general, it may be necessary to “age” previous topics and categories and give importance to more recent interests of the user.

One embodiment of the present invention determines if an object in the database is relevant to what the current user by the standard cosine similarity of the two vectors defined as:

$$cos θ = \frac{{d}_{2} \cdot q}{‖ {d}_{2} ‖ ‖ q ‖}$$

Where,

d2·q is the dot product (or inner product) of the document or object vector and the user profile vector.

Notice that the running time is linear in the number of objects in the database, however, this process can be speeded up by maintaining an inverted index. Furthermore, in some embodiments, it is assumed that the database of objects is not on the mobile device but is deployed alongside the backend system or in a suitable manner. Also, in the same or other embodiments, the entire matching process can be significantly different and more complicated than doing a simple cosine similarity.

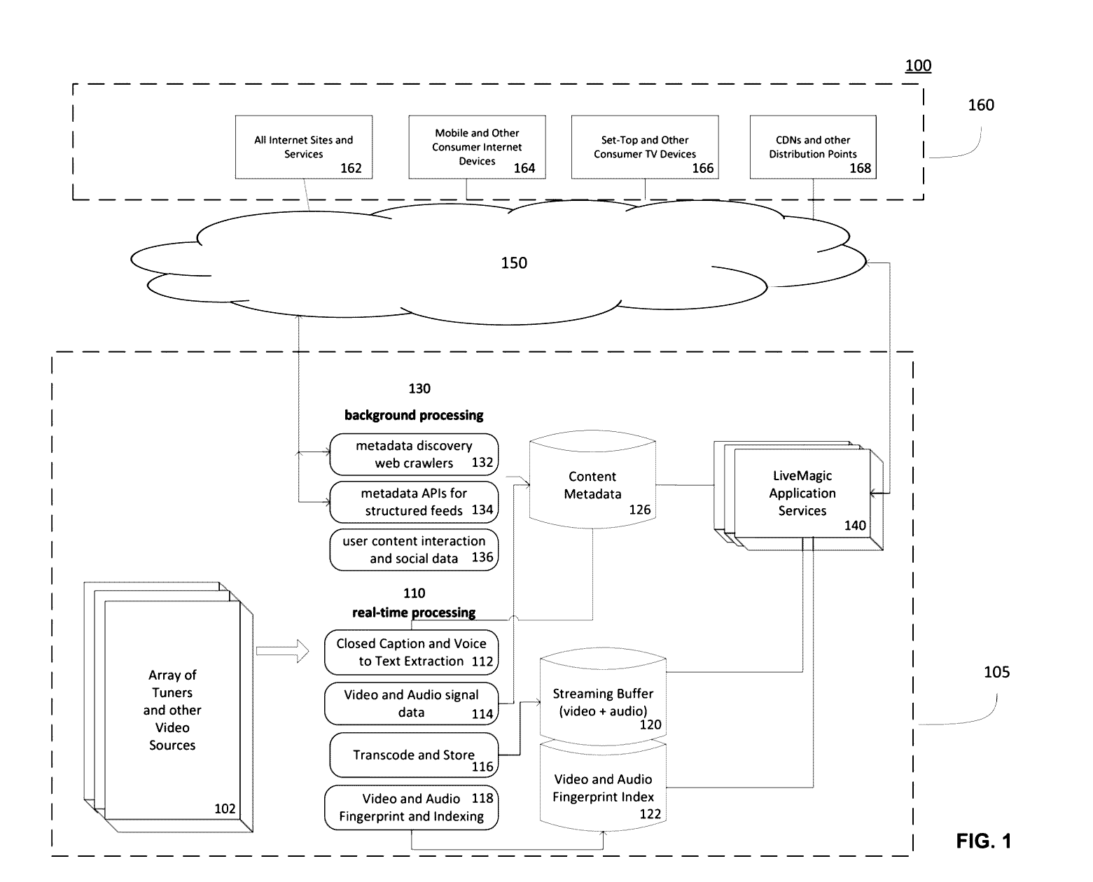

Turning to the drawings, FIG. 1 illustrates an example of a system 100 for streaming content, according to an embodiment. In the same or different embodiments, system 100 can be a digital video recorder (DVR) system for streaming content and user interaction. System 100 is merely exemplary and is not limited to the embodiments presented herein. System 100 can be employed in many different embodiments or examples not specifically depicted or described herein.

According to some embodiments, the system can comprise a backend and a frontend. The backend can be used for content acquisition in these embodiments. Examples of backend components are shown in the box defined as 105 in FIG. 1. The frontend can comprise apps that rune on consumer devices such as, for example, mobile phones, tablets, internet-enabled set-top-boxes, computers, smart televisions, and the like. Examples of frontend components are shown in the box defined as 160 in FIG. 1.

In the embodiment of FIG. 1, system 100 comprises one or more video components 102. Video components 102 can include an array of tuners capable of receiving and delivering video signals. The video turners can include, for example, boxes capable of receiving a cable television input, boxes capable of receiving a satellite television input, boxes capable of receiving a fiber optic input, antennas signals capable of receiving over-the-air television broadcasts, or combinations thereof. In some embodiments, one or more video components may be able to transmit all television programming from broadcast, cable, and/or satellite providers to a processing unit. In addition, video components can comprise devices that produce video signals from DVDs, BDs, CDs, internet sources, and the like. It should be noted that video components 102 can comprise any devise capable of producing a video signal. Also, in addition to the video signals that are produced from video components 102, there can also be audio signals coupled to the video signals.

System 100 can also comprise a processing unit 110. In some embodiments, processing unit 110 can be considered a real-time processing unit. Processing unit 110 is where the processing of the video (and audio) signals received from the one or more video components 102 occurs. Processing unit can comprise a closed caption unit 112; a signal data unit 114; a transcoding unit 116; and a fingerprinting unit 118.

The closed caption unit 112 can take the closed caption data from the video/audio feeds as received from the video components 102. The data can be mined for information relating to the video signal that is incoming. For example, if the video signal coming from video components 102 is representative of a football game, the closed caption may comprise the word “touchdown.” This is indicative of something that has occurred in the football game and can be stored as metadata. In addition the closed caption unit 112 can also perform voice to text extraction. As an example, the audio signal can be translated to text. For example, the announcer may say “touchdown” in the football example. Once again, this is important information that can be saved as metadata.

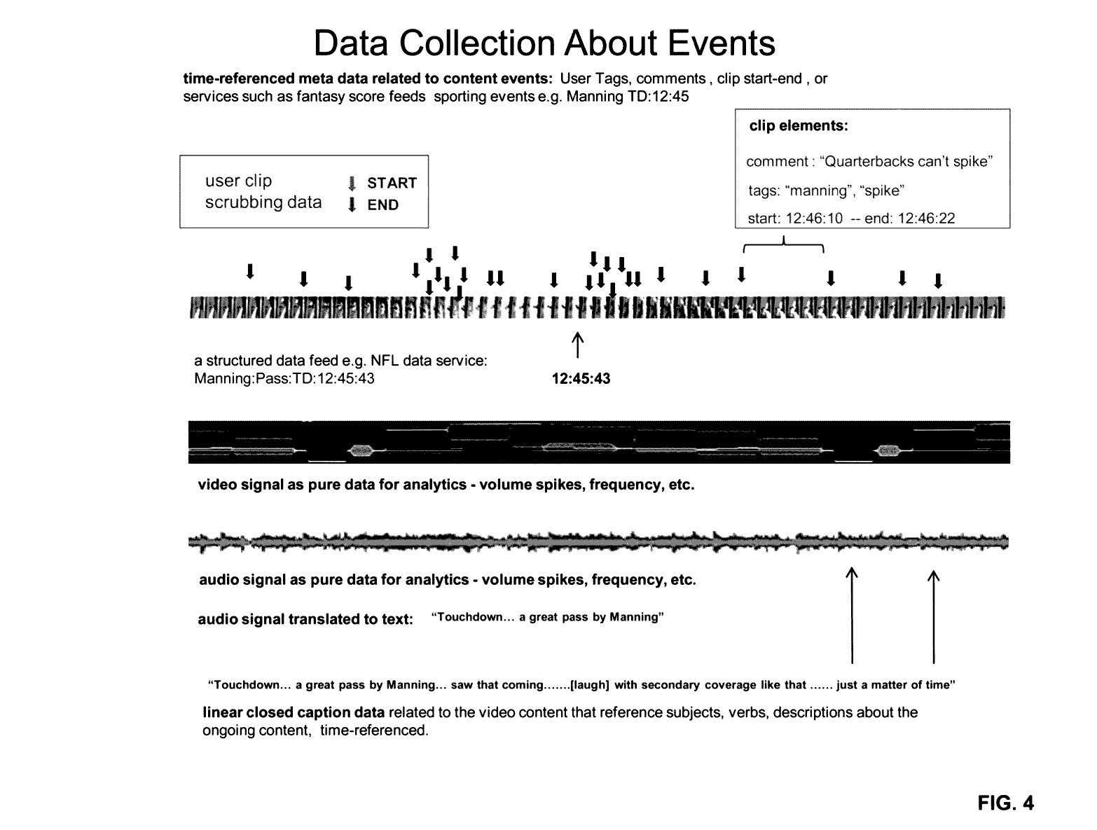

The signal data unit 114 can take the audio and video data signals and mine those signals for pertinent information, which can be stored as metadata. FIG. 4 shows examples of audio and video signals and the types of information that those respective signals can contain. As examples, volume spikes, frequency, etc. can be used to determine whether an important moment in the television program has taken place.

The transcoding unit 116 can take the signals (video and audio) received from the video components 102 and transcode and store the signals. Transcoding allows the signals to be converted to a uniform file format and allows for a compression of the files. The transcoding unit can use any number of transcoding methods now known or hereinafter developed.

The fingerprinting unit 118 can comprise audio fingerprinting and video fingerprinting capabilities. The audio fingerprinting takes the audio signal as received from the video components 102 and processes the audio signal to generate a compact fingerprint that can uniquely represent the audio. In some examples the audio fingerprint module processes chunks of audio (for example, a chunk of seven seconds of audio can be used, although it should be noted that this more than seven seconds or less than seven seconds of audio signal can be used). In some examples, the audio is processed using fast fourier transform and other audio processing algorithms. In some embodiments, the fingerprint is a list of integers. In the same or other embodiments, the number of such integers generated ranges of approximately 30-50 per second of audio. In some embodiments, the number of such integers ranged less than approximately 30 per second of audio. In other embodiments, the number of such integers ranged greater than approximately 50 per second of audio. In some embodiments of the present invention, a total of approximately 20 seconds of audio is captured to determine the matching program. It should be noted that more than or less than 20 seconds of audio can be used.

The video fingerprinting takes the video signal as received from the video components 102 and processes the video signal to generate a compact fingerprint that can uniquely represent the video received. In some examples, the video is processed scene by scene, thus allowing a still picture of a video to matched using the fingerprinting analysis. In other examples, the video is processed using a particular amount of time of the video signal. Any amount of time can be used to process the video.

System 100 can also include a number of databases. These databases can be used to store data obtained from the video components 102 after the data has been processed by the processing unit 110. In the same or other embodiments, data obtained from the video components 102 may be stored in a database without being processed by the processing unit 110. Embodiments of the present invention can comprise a fingerprint database 122, a streaming buffer database 120, and a content metadata database 126. In some embodiments fingerprint database 122, streaming buffer database 120, and metadata database 126 may be a single database. In other embodiments, one or more of fingerprint database 122, streaming buffer database 120, or metadata database 126 can comprise a plurality of databases. In addition system 100 can also include other databases not specifically mentioned herein.

In the example illustrated in FIG. 1, data that has been processed by the fingerprinting unit 118 is stored within the fingerprint database 122. This data can include, for example, the fingerprints of the video data and/or the audio data that has been received from the video components 102.

According to the example of FIG. 1, data that has been processed by the transcoding unit 116 is stored within the streaming buffer database 120. This data can include, for example, the transcoded video and/or audio data that has been received from the video components 102.

Also, as shown in the example of FIG. 1, data that has been processed by the closed caption unit 112 and the signal data unit 114 is stored within the content metadata database 126. This data can include, for example, data that is gleaned from the incoming data video and/or audio signals (such as, for example volume spikes and/or frequency). In addition the data can also include data that has been extract from the closed caption data of the video signals and/or data that has been extracted by converting the voice data found in the audio signals to text.

With continued reference to FIG. 1, system 100 can include a network 150. As an example, network 150 can comprise the Internet and/or a cellular telephone/data network. In other examples, network 150 can comprise a network specifically created for the systems and methods discussed herein.

System 100 can also comprise a background processing unit 130. Background processing unit 130 can be connected with the network 150. Background processing unit 130 is where the processing of the how people interact with the video (and audio) signals received from the one or more video components 102. The background processing unit 130 is capable of processing pertinent information relating to particular video clips. For example, the background processing unit 130 can determine how people view clips of video, such as how often a particular video clip is played, how often a particular video clip is shared, or how often a particular video clip is skipped. Background processing unit can comprise a metadata discovery web crawlers unit 132; an API unit 134; and a user content interaction unit 136.

The metadata discovery web crawlers unit 132 can search the network 150, which can be the Internet for any type of information relating to a particular video clip. The data that is discovered can then be stored as metadata. For example, a video clip may be tagged with the word “touchdown,” or there may be one or more comments regarding a football game, which has one or more video clips pertaining to it, on a website. In some embodiments, the metadata is stored in the content metadata database 126.

The API unit 134 can receive structured feeds from the network 150. These feeds can include, for example, feeds from real-time scoring services that provide real-time scoring updates, statistics, and other pertinent information from sporting events. Other types of structured feeds can also be processed via the API unit 134. In some embodiments, the data processed via the API unit 134 is stored in the content metadata database 126.

The user content interaction unit 136 can receive information on how users interact with clips and how the clips are shared on social networks. For example, the user content interaction unit 136 can determined how many times a clip has been share, viewed, skipped, etc. Furthermore, it can track what is trending, etc. In some embodiments, the data processed via the user content interaction unit 136 is stored in the content metadata database 126.

With continued reference to FIG. 1, system 100 can also comprise an application services unit 140. The application services unit can be configured to be connected to content metadata database 126, streaming buffer database 120, and fingerprint database 122. In addition, the application services unit can be connected to the network 150.

The application unit 140 is capable of running the applications of the system. Examples of the types of services and applications that can be performed by the application unit 140 can include, searching for video content, clipping and sharing videos, building a playlist of video clips, learning more about video content, automatically generating video clips, creating a fantasy sports playlist, etc. It should be noted that any number of applications can be run by the application service unit 140.

System 100 also includes frontend components 160. Frontend components 160 can include, for example, Internet sites and services 162, consumer devices 164, set-top devices 166, and CDNs 168. Each of the frontend components 160 is connected to the backend components 105 via the network 150. It should be noted that the frontend components can include other devices not specifically mentioned herein.

Internet sites and services 162 can include, for example, all other Internet sites. As an example, the system is connected to the Internet and can interact with any website or service that is similarly connected to the Internet.

Consumer devices 164 can include, for example, any mobile device or computer that consumers use to connect to the Internet. A mobile device can be any type of device that can receive data wirelessly from an external source. For example, a mobile device can be an Apple iPhone® device, a Blackberry® device, a telephone with an Android™ operating system, a mobile telephone, a PDA (personal digital assistant), an MP3 player, a portable computer, a tablet device, and/or other similar devices. A computer can be any computer that has access to the Internet or similar network connection. A computer can be a laptop and/or a desktop computer. It should be noted that the devices listed as examples for mobile devices and/or computers can include other devices than those specifically mentioned.

Set-top devices 166 can include, for example, smart televisions, Google® TV, and other similar boxes which can connect a television to the Internet. It should be noted that the devices listed as examples for set-top devices can include other devices than those specifically mentioned.

CDNs 168 can include, for example, content delivery networks (CDNs) and broadcasters. Examples of types of providers that can be considered CDNs 168 can include, hotels, cable providers, such as for example, Comcast®, satellite providers, and the like. In some examples, CDNs 168 will allow a user to create a personalized television channel, allowing the user to view a series of video clips created by the user. In some embodiments, such a personalized channel is created with application services unit 140.

The various components of system 100 can be configured a number of different ways. For example, the units (background processing unit 130, the processing unit 110, and the application services unit 140) can comprise one or more computers, servers, processing units, and the like.

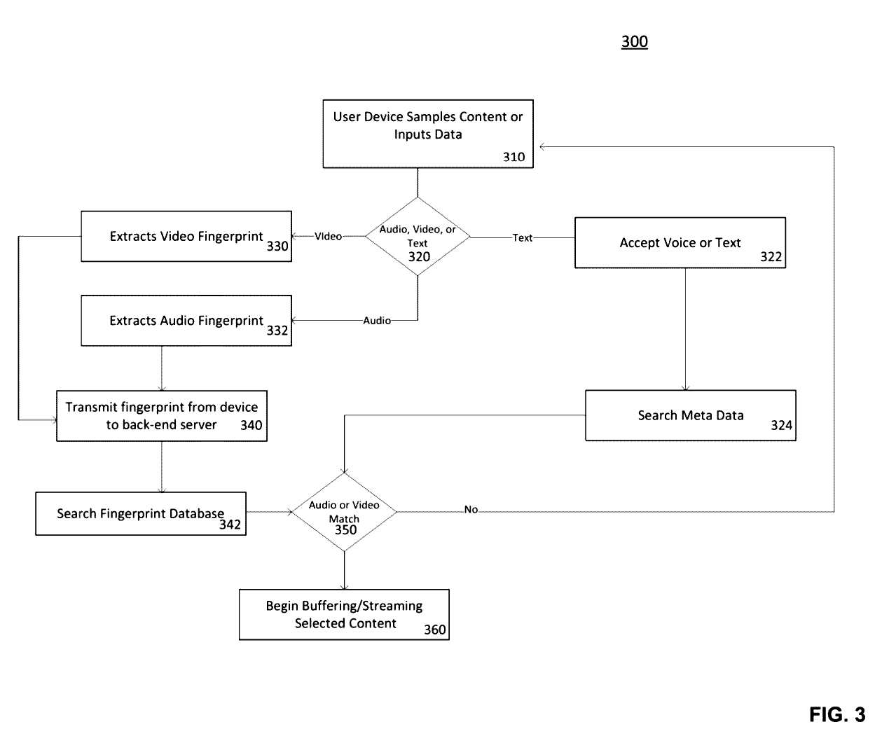

FIG. 3 is a flow chart illustrating an example of a method 300 of detecting video content. Method 300 can also be considered a method for detecting a particular video stream via video, audio, or voice/text information. Method 300 is merely illustrative of a technique for implementing the various aspects of certain embodiments described herein, and method 300 is not limited to the particular embodiments described herein, as numerous other embodiments are possible. In some embodiments, the various procedures of method 200 can be performed by single computer or a set of computers.

Method 300 can include a procedure 310 of receiving an input from a user. The input can be in many different formats and can come from different types of devices, such as for example, mobile devices and/or computers. For example, the input can include audio, video, text, or voice. The video input, for example, can be a screen shot of a television program taken with the camera of a mobile device. In other examples, the video input can be a recorded video for a particular period of time. The audio input, for example, can be an audio stream received from a mobile device. The text input can include a user entering text into a query on an application on a computer or mobile device. The voice input can include a user speaking into a mobile device to enter a query.

Next method 300 includes a procedure 320 of deciphering what type of input the user entered. In one example, during procedure 320 it is determined whether the user inputted video, audio, or voice/text data.

If the inputted data is video data, procedure 320 is followed by procedure 330. Procedure 330 is extracting the video fingerprint of the video data. If the inputted data is audio data, procedure 320 is followed by procedure 332. Procedure 332 is extracting the audio fingerprint from the audio data. In some embodiments, procedures 330 and 332 are performed on frontend components 160 of system 100. For example, procedures 330 and 332 can be performed by a mobile device.

Once the fingerprint (audio or video) has been extracted, the fingerprint is transmitted to the backend components 105 during procedure 340. In some examples, the fingerprint is transmitted to the backend components 105 via network 150 from a mobile device.

Next, method 300 can continue with a procedure 342 of searching a fingerprint database. The fingerprint database can be the same as or similar to fingerprint database 122. The fingerprint database is being searched for a fingerprint that matches the fingerprint that was sent via the device during procedure 340.

After procedure 342, method 300 continues with a procedure 350 of determining if there was a corresponding match for the inputted data. For example, if the inputted data was an audio stream, procedure 350 determines whether there is a fingerprint that matches the fingerprint extracted during procedure 332 and transmitted during procedure 340. Likewise, if the inputted data was video data, procedure 350 determines whether there is a fingerprint that matches the fingerprint extracted during procedure 330 and transmitted during procedure 340.

If there is a match, method 300 continues with a procedure 360 of streaming the selected content to the user. The content can be streamed, for example, to the user's mobile device or computer. In addition, procedure 360 can include buffering. In some embodiments, the streaming is conducted via network 150.

If there is not match, method 300 can continue with procedure 310. For example, the device may ask the user to enter another input (video, audio, or voice/text) to commence another search.

If the inputted data is text or voice data, procedure 320 is followed by a procedure 322. Procedure 322 is accepting the voice or text data from the user's device. In some examples, the voice or text data is transmitted to the backend components 105 from the frontend components 160 via network 150 during procedure 322. In yet other examples, if the data is voice data, the voice data is transformed to text data during procedure 322.

Procedure 322 is followed by a procedure 324 of searching the metadata to find a matching video. The metadata can be stored in the content metadata database 126.

After procedure 324, method 300 continues with a procedure 350 of determining if there was a corresponding match for the inputted data. For example, after the metadata was searched, there will be a determination if there are one or more video clips that match user's input.

If there is a match, method 300 continues with a procedure 360 of streaming the selected content to the user. The content can be streamed, for example, to the user's mobile device or computer. In addition, procedure 360 can include buffering. In some embodiments, the streaming is conducted via network 150.

If there is not match, method 300 can continue with procedure 310. For example, the device may ask the user to enter another input (video, audio, or voice/text) to commence another search.

It should be noted that method 300 and its procedures are merely exemplary. Many of the procedures can be rearranged without limiting the scope of the invention. In addition, other procedures not mentioned herein can be included within method 300 and/or procedures mentioned with respect to method 300 do not need to be included.

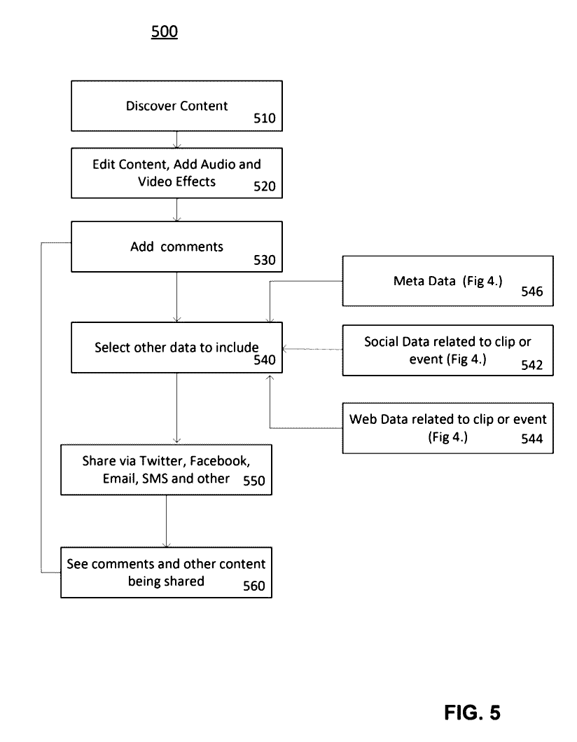

FIG. 5 is a flow chart illustrating an example of a method 500 of interacting with content clips. Method 500 can also be considered a method for social interaction with video clips. Method 500 is merely illustrative of a technique for implementing the various aspects of certain embodiments described herein, and method 500 is not limited to the particular embodiments described herein, as numerous other embodiments are possible. In some embodiments, the various procedures of method 500 can be performed by single computer or a set of computers.

Method 500 can include a procedure 510 of discovering content. Procedure 510 can comprise a user receiving a streaming video or a particular video clip on a device. The device can be a mobile device or a computer. Other devices can be included also. The video (or audio, or a combination thereof) is delivered to the user device from backend components via a network. The network can be the same as or similar to network 150 and the backend components can be the same as or similar to backend components 105. Procedure 510 can be the same as or similar to method 300 of FIG. 3. In other examples, procedure 510 is not the same as method 300.

Next, method 500 can include a procedure 520 of editing the content of the video. As an example, the user can edit the content of the video and/or add effects. The effects can include audio effects, video effects, or combinations thereof. The editing can be accomplished using frontend components or backend components. An example of editing can include editing the length of the clip. The front end components can be the same as or similar to front end components 160 and the back end components can be the same as or similar to back end components 105.

Method 500 can further comprise a procedure 530 of adding comments. A user can use a device to add comments to the video clip that has been delivered to the user's device and may have been edited. A user can choose to comment on the video, which will be shared with other users.

After procedure 530, method 500 can continue with a procedure 540 of selecting other data to include with the video clip. Examples of other data that can be included with the video clip can comprise metadata, social data, and/or web data. Metadata can be added to the video clip using a procedure 546. Social data can be added to the video clip using a procedure 542. Web data can be added to the clip using a procedure 544. The metadata, social data, and web data can be the same as or similar to the data processed by the background processing unit 130 and stored within the metadata database 126.

After any other data has been added to the video clip, method 500 can continue with a procedure 550 of sharing the video clip. In procedure 550, a user can select to share the video clip that has been delivered to the phone, edited, had comments added, had other data added, or combinations thereof. The user can choose to share the video clip on social networking sites (such as, for example, Twitter, Facebook, G+), via email, SMS, or any other methods.

Next, method 500 can proceed with a procedure 560 of seeing comments and other content being shared. During procedure 560, a user can see comments that other users have made with respect to the video. In addition, a user can view other content, which can include video clips uploaded by other users, share by other users. In addition, after a video clip has been shared, more comments and other data can be added by the user or other users with respect to the shared video clip. As an example, after procedure 560 method 500 can continue with procedure 530.

It should be noted that method 500 and its procedures are merely exemplary. Many of the procedures can be rearranged without limiting the scope of the invention. In addition, other procedures not mentioned herein can be included within method 500 and/or procedures mentioned with respect to method 500 do not need to be included.

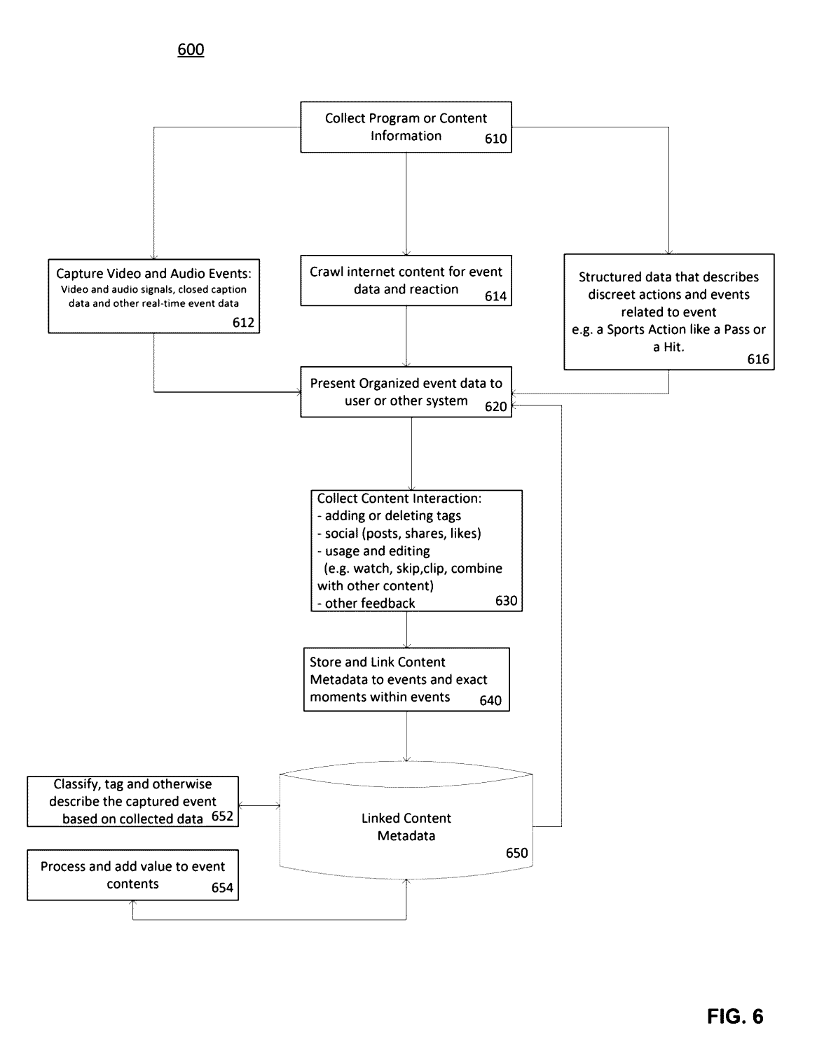

FIG. 6 is a flow chart illustrating an example of a method 600 of collecting event and interaction data. The data collected during method 600 can be the same as or similar to the data added to the video clip during procedure 540 (metadata 546, social data 542, or web data 544) of method 500. Method 600 is merely illustrative of a technique for implementing the various aspects of certain embodiments described herein, and method 600 is not limited to the particular embodiments described herein, as numerous other embodiments are possible. In some embodiments, the various procedures of method 600 can be performed by single computer or a set of computers.

Method 600 has a procedure 610 of collecting program data. The program data can include any program or content information related to a video clip. As an example, video and audio events can be captured during a procedure 612. Audio and video events can include, for example, data related to video and/or audio signals, closed caption data, and other real-time event data.

As another example, Internet content can be captured during a procedure 614 of carling the Internet for vent data and reaction. As an example, the Internet can be mined for comments, data, etc. for information about events. As previously mentioned, events can include, for example, television programs, sporting events, and the like.

As yet another example, structured data can be captured during a procedure 616 of capturing structured data. As an example, structured data can include data that describes discrete actions and events as they relate to a particular event. For example, during a football game, the action may be a pass. As another example, during a baseball game, the action may be a hit.

Method 600 continues with a procedure 620 of presenting organized event data to a user or other system. The organized data can include, for example, the data captured during procedures 612, 614, and/or 616.

Next, method 600 can comprise a procedure 630 of collecting content interaction. The content interaction can include, for example, adding or deleting tags to a video clip, social usage data (posts, shares, likes, etc.), usage and editing data (watches, skips, clips, combinations with other content, etc.), and/or other feedback. Procedure 630 enables the actions of a wide variety of users to inform the system of what is important and happening in the world.

Procedure 640 follows. Procedure 640 is a procedure for storing and linking content metadata to events and exact moments during a particular event. For example, a touchdown may occur during a particular point during a football game. Procedure 640 allows a video clip to have an exact time in which said touchdown occurred. In addition, other data can be added to any clip. As shown in FIG. 6, the data is stored in 650. In some embodiments, the data can be stored in a database that is the same as or similar to metadata database 126.

Method 600 can continue back to process 620. This allows more and more content to be added to any individual clip. This allows for a robust collection of clips with all sorts of data attached to them.

After 650, method 600 can include a procedure 652 and/or a procedure 654. Procedure 652 can comprise classifying, tagging, and/or otherwise describing the captured event based on the data that has been collected during method 600. Procedure 654 can comprise processing and adding value to event contents.

In addition, data related to any particular video clip can include Digital Rights Management (DRM) data. For example, certain clips may be limited to a certain type of user, such as, for example, a premium user. A copyright holder may only allow a certain number of their clips to be shared, edited, etc. The systems and procedures of the present invention allow for management of DRM issues.

It should be noted that method 600 and its procedures are merely exemplary. Many of the procedures can be rearranged without limiting the scope of the invention. In addition, other procedures not mentioned herein can be included within method 600 and/or procedures mentioned with respect to method 600 do not need to be included.

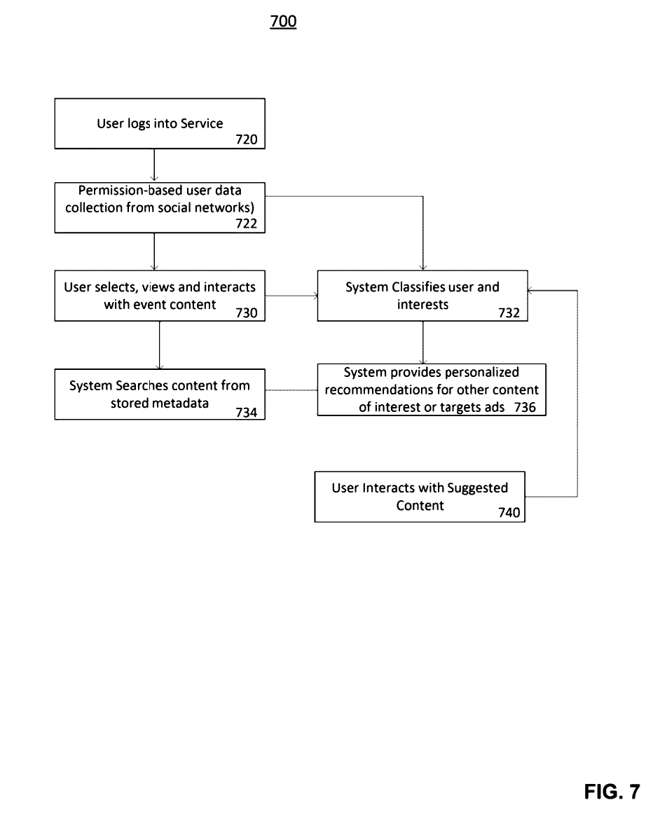

FIG. 7 is a flow chart illustrating an example of a method 700 of recommending content. Method 700 can be considered a method for informing a user of content that a user may be interested in. Method 700 is merely illustrative of a technique for implementing the various aspects of certain embodiments described herein, and method 700 is not limited to the particular embodiments described herein, as numerous other embodiments are possible. In some embodiments, the various procedures of method 700 can be performed by single computer or a set of computers.

Method 700 comprises a procedure 720 of a user logging into a particular service. An example of the service can include LiveMagic™ services. Method 700 continues with a procedure 722 of collecting user data from social networks. In some examples, the service app that a user has signed into will gain authorization from other social networks for access to the user's account at the other social networking sites.

Method 700 continues with a procedure 730 of a user selecting, viewing, and/or interacting with event content. Method 700 also comprises a procedure 732 of the system classifying users and their interests. This can be done in at least part based on the history of the user and the content they search, view, and interact with. In addition, any additional data associated with any event clips, such as, for example, metadata can also be instrumental in classifying a user's interest.

Method 700 also comprises a procedure 734 of searching for content from stored metadata. Furthermore, from this search, which may me similar to or the same as aspects of the example of FIG. 6, method 700 can continue with a procedure 736 of providing personalized recommendations of content that the user may enjoy. In addition, the system can also present targeted advertisements to the user based on the user's likes and interests.

Next, procedure 700 can comprise a method 740 of the user interacting with the suggested content. The systems is able to further gage the user' interested by how the user interacts with the suggested content.

It should be noted that method 700 and its procedures are merely exemplary. Many of the procedures can be rearranged without limiting the scope of the invention. In addition, other procedures not mentioned herein can be included within method 700 and/or procedures mentioned with respect to method 700 do not need to be included.

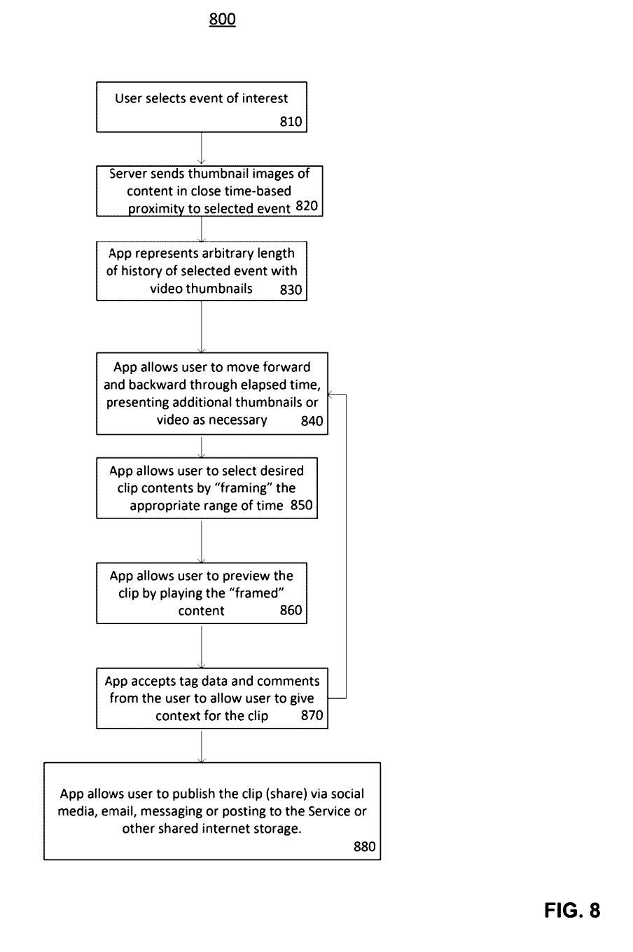

FIG. 8 is a flow chart illustrating an example of a method 800 of creating clips. Method 800 can be considered a method for creating video clips for a user. Method 800 is merely illustrative of a technique for implementing the various aspects of certain embodiments described herein, and method 800 is not limited to the particular embodiments described herein, as numerous other embodiments are possible. In some embodiments, the various procedures of method 800 can be performed by single computer or a set of computers.

Method 800 can comprise a procedure 810 of a user selecting an event of interest. Procedure 810 can be the same as or similar to method 300 of FIG. 3.

Method 800 continues with a procedure 820 of sending images to the user regarding the chosen event. In some example, the server sends thumbnail images of the content in close time-based proximity to the selected event.

Next, method 800 continues with a procedure 830 of representing an arbitrary length of history of the selected event with video thumbnails. For example, the user can be presented with a series of video thumbnails, each comprising an arbitrary length of time. This length of time can be a few second, 30 seconds, or even a couple of minutes. It should be noted that any arbitrary length of time can be selected.

Method 800 can further comprise a procedure 840 of allowing the user to move forward or backward through elapsed time. In some examples, the procedure 840 allows a user to be presented with additional thumbnails as necessary to find the desired range of thumbnails for the user's chosen content. For example, the user has chosen a football game event. However, the user wants to view something from the first quarter of the event, but the user didn't detect the event until the third quarter of the football game. Since considerable time has passed, the user will be able to be presented with more and more thumbnails of videos until the user gets to the time period in which the user was interested.

Next, method 800 comprises a procedure 850 of allowing a user to select a desired clip contents by framing the appropriate range of time. As an example, the user may want to have clip from a particular starting action to a particular ending action. As such, the user can then choose what that starting action is and what the ending action is, and creates a clip that lasts that time period.

Method 800 continues with a procedure 860 of allowing the user to preview a clip by playing the framed content chosen during procedure 850. This allows a user to make sure that he or she has framed the right content to create an appropriate clip.

After 860, method 800 continues with a procedure 870 of accepting tag data and/or comments from the user with respect to the clip. The user can add comments and/or data as previously discussed. This provides more information to the clip for future use, classification, etc.

Next, method 800 comprises a procedure 880 of allowing a user to share or publish the clip. As previous discussed, this can include sharing via social networks, email, SMS, social media, posting to a LiveMagic™ service, or other similarly shared internet storage.

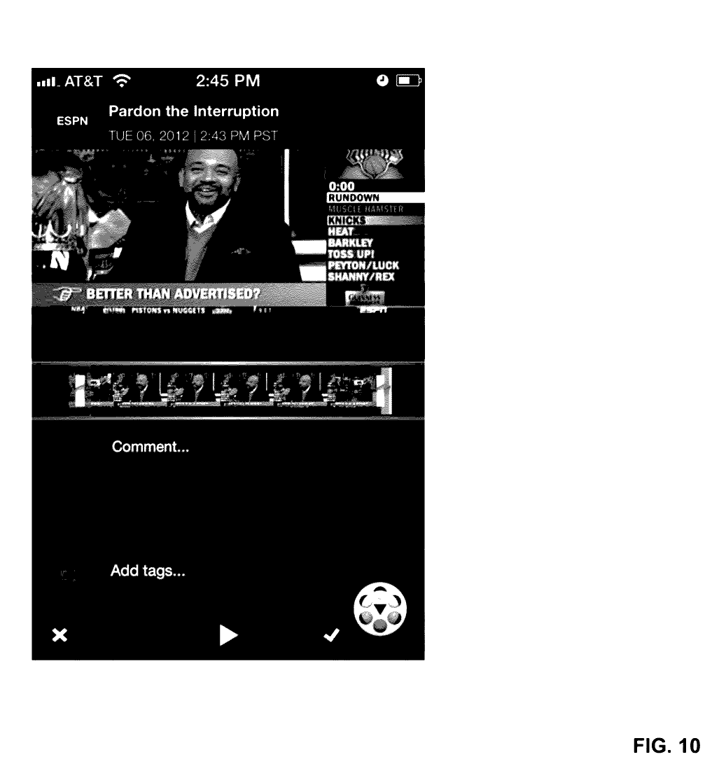

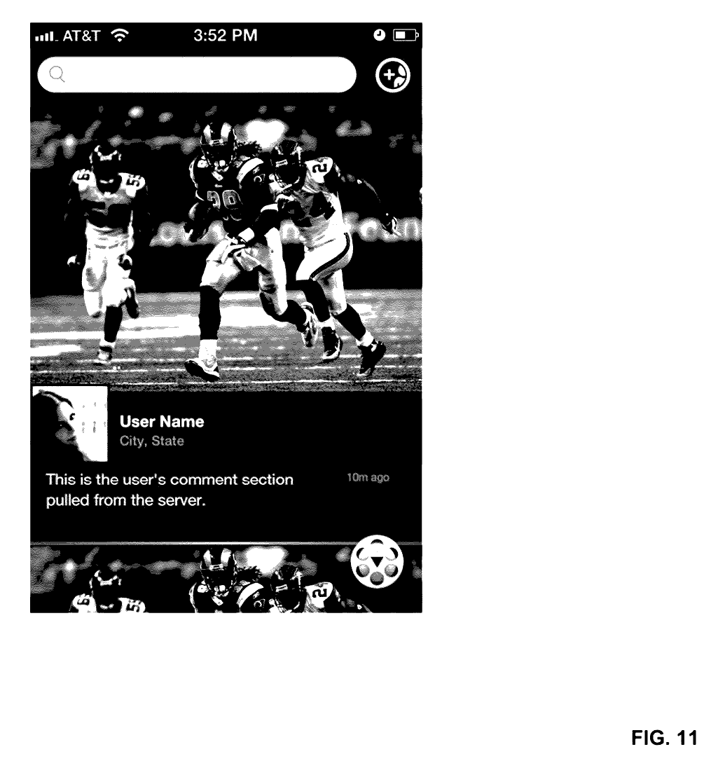

As examples, FIGS. 10 and 11 illustrate examples of screen shots of a mobile device displaying one or methods according to an embodiment. In particular, FIGS. 10 and 11 can be seen as examples of screen shots of a mobile device displaying a method of creating clips.

It should be noted that method 800 and its procedures are merely exemplary. Many of the procedures can be rearranged without limiting the scope of the invention. In addition, other procedures not mentioned herein can be included within method 800 and/or procedures mentioned with respect to method 800 do not need to be included.

According to further embodiments of the present invention, the systems and methods presented herein allow a user to view video clips on a mobile device in a resolution that is suitable for said device. However, such resolution may be less than what a user would like to share on a social network. For example, a user may prefer to view video on his or her mobile device in standard definition (SD). For example, a user may wish to view SD on his or her mobile device due to bandwidth or resolution issues on the mobile device. However, when on a computer or on an Internet enabled television, a user may prefer to view the clips in high definition (HD). As such, in the embodiments presented herein, a user can view, edit, comment on, and share a clip on a mobile device on which the user is viewing the video in SD. However, once the clip is uploaded to another site, the clip is uploaded in HD.

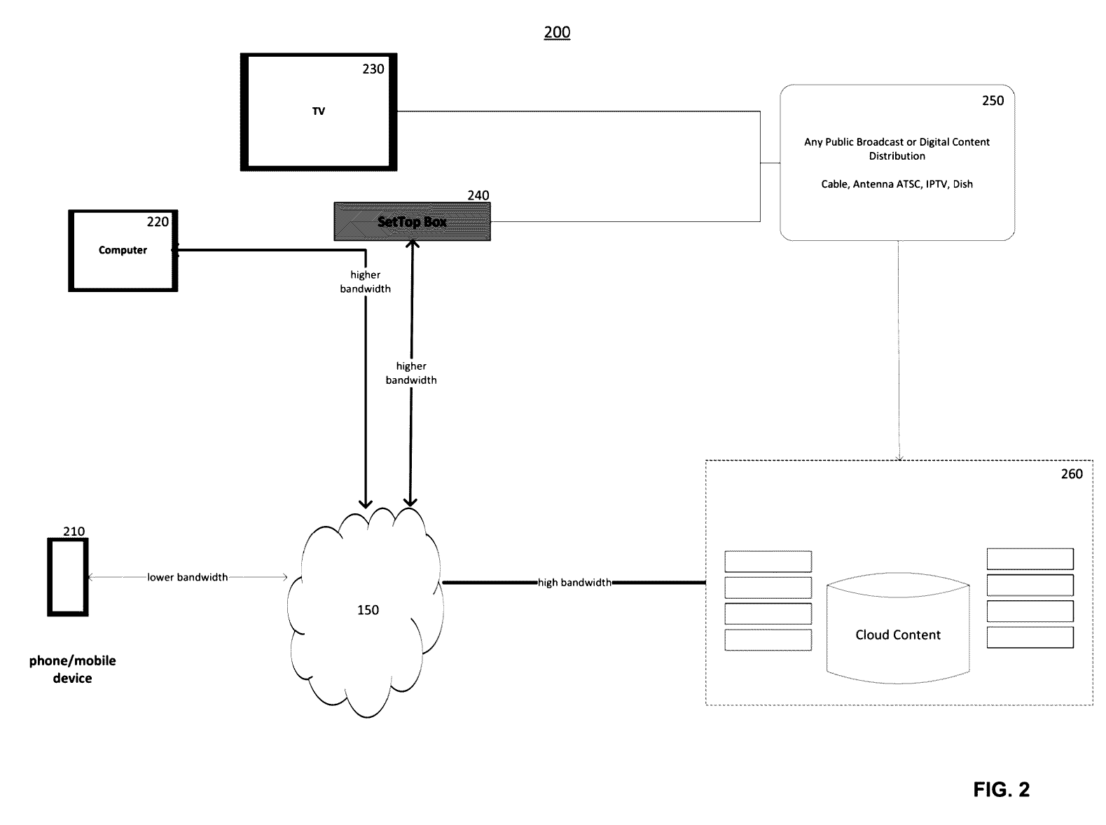

FIG. 2 illustrates an example of a system 200 for streaming content, according to an embodiment. In the same or different embodiments, system 200 can be a digital video recorder (DVR) system for streaming content and user interaction. System 200 is merely exemplary and is not limited to the embodiments presented herein. System 200 can be employed in many different embodiments or examples not specifically depicted or described herein.

System 200 can be the same as or similar to system 100. System 200 can comprise a mobile device 210, a computer 220, a television 230, a set-top box 240, and content distributors 250. Mobile device 210, computer 220, television 230, set-top box 240, and content distributors 250 can be the same as or similar to front end components 160 of FIG. 1.

Furthermore, system 200 can comprise a network 150. In addition, system 200 can comprise backend components 260. Backend components 260 can be the same as or similar to backend component 105 of FIG. 1.

As illustrated n FIG. 2, mobile device 210 may communicate with network 150 at a lower bandwidth than computer 220, set-top box 240, or backend components 260. This may be because mobile device 210 is communicating with network 150 through a cellular connection. Since, the video is uploaded to any cites from backend components 260, rather than the phone directly, the video uploaded anywhere can be HD. In addition, if the backend components 260 detect that a user is on a mobile device, in some examples, it may upload video clips to the device in SD. However, if it is acceptable for the mobile device to receive HD video, then the system will allow that too.

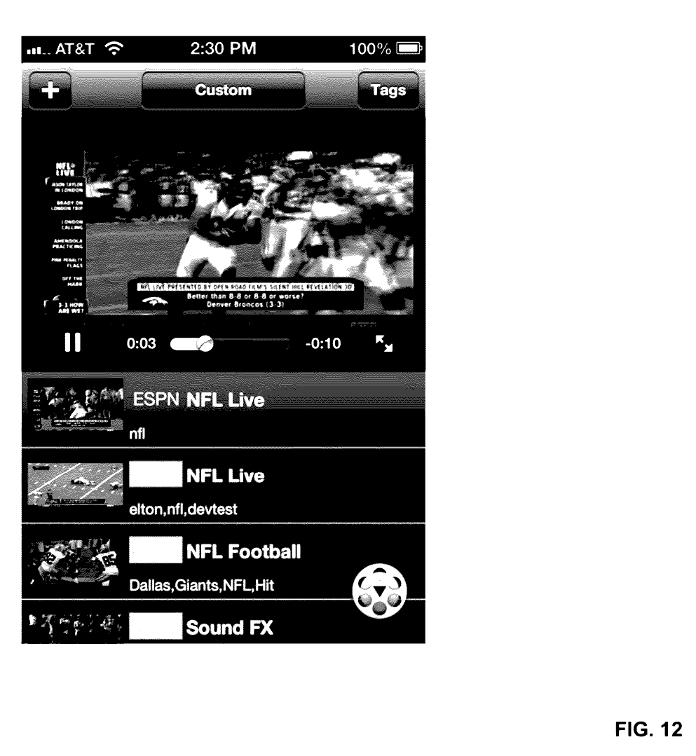

As an example, FIG. 12 illustrates an example of a screen shot of a mobile device displaying one or methods according to an embodiment. In particular, FIG. 12 can be seen as an example of a screen shot of a mobile device replaying a clip.

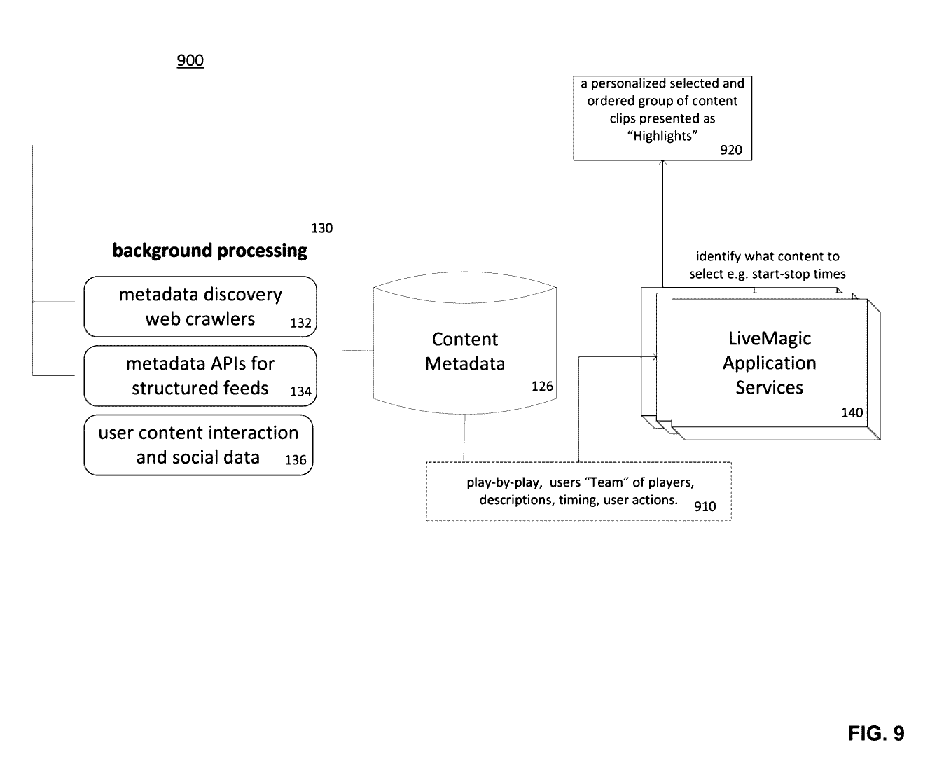

FIG. 9 illustrates a system 900 for creating an automated playlist, according to an embodiment. In the same or different embodiments, system 900 can be a system for creating a fantasy sports playlist. System 900 is merely exemplary and is not limited to the embodiments presented herein. System 900 can be employed in many different embodiments or examples not specifically depicted or described herein. System 900, in some embodiments, can be considered to be a portion of system 100 of FIG. 1.

As shown in FIG. 9, system 900 can include a background processing unit 130, a metadata database 126 and an application services unit 140. System 900 also includes metadata related to a particular interest of a user. For example, a user may have a fantasy football team. Therefore, the metadata may comprise the names of the players on the user's fantasy football team. Therefore, using the methods and systems previous discussed herein, system 900 can send selected content 920 to frontend components. Content 920 can include a personalized selected and ordered group of content clips presented as “highlights” to the user. As an example, content 920 can include all of the highlights from any player on a user's fantasy football team. It should be noted that system 900 can be used for examples other that fantasy sports. For example, a user can create a list of his or her favorite athletes or favorite sports teams. In addition, a user could create a list of his or her actors. There are numerous possibilities of the types of lists that a user can create.

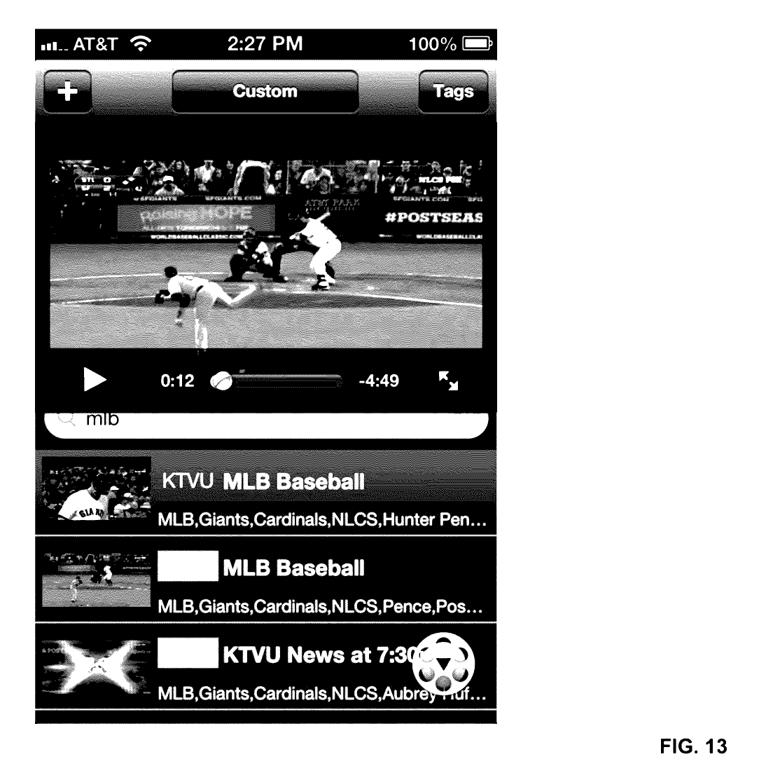

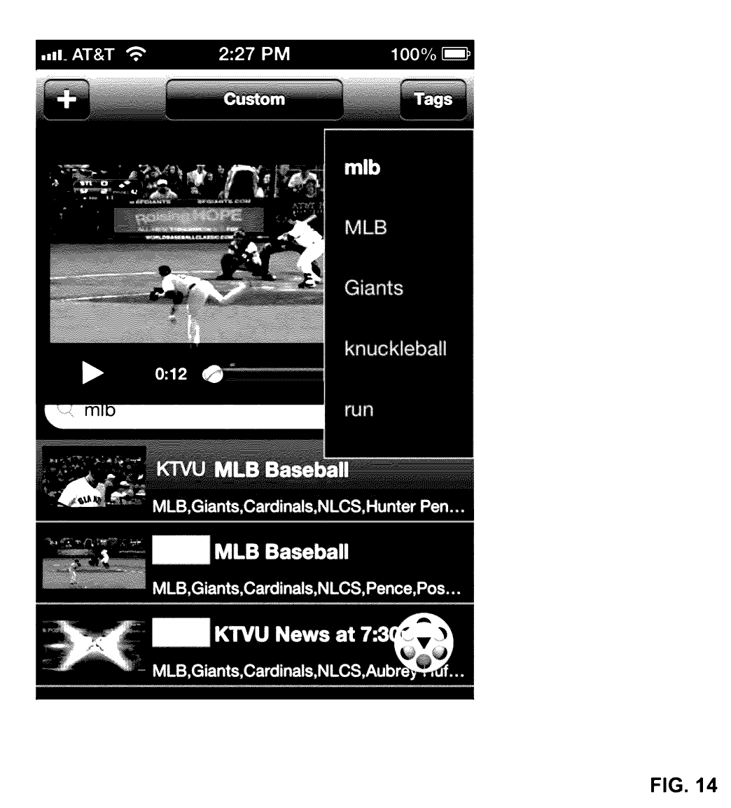

As examples, FIGS. 13 and 14 illustrate examples of screen shots of a mobile device displaying one or methods according to an embodiment. In particular, FIGS. 13 and 14 can be seen as examples of screen shots of a mobile device displaying highlights according to at least one embodiment. FIG. 13 shows an example of a highlight without tags and FIG. 14 shows an example of a highlight with tags.

Although the invention has been described with reference to specific embodiments, it will be understood by those skilled in the art that various changes can be made without departing from the spirit or scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the semiconductor device and its methods of providing the semiconductor device discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of interacting with user content, comprising detecting an event;
interacting with the event;
collecting data on the event;
creating one or more clips based on the event; and
sharing the one or more clips.

2. The method of claim 1, wherein:
detecting the event comprises using audio fingerprinting.

3. The method of claim 2, wherein:
the audio fingerprinting comprises background matching.

4. The method of claim 1, wherein:
detecting the event comprises using video fingerprinting.

5. The method of claim 1; wherein:
interacting with the event comprises a user adding comments to the event.

6. The method of claim 1, wherein:
interacting with the event comprises added metadata to the event.

7. The method of claim 1, wherein:
collecting data comprises capturing audio events from the audio signal.

8. The method of claim 1, wherein:
collecting data comprises capturing video events from the video signal.

9. The method of claim 1; wherein:
creating one or more clips comprises provided one or more thumbnails representative of a video sequence.

10. The method of claim 9; wherein:
creating one or more clips further comprises a user selecting one of the one or more thumbnails representative of a video sequence; and
the user framing a period of time to create the duration of the video clip.

11. The method of claim 10, wherein:
creating one or more clips further comprises a user previewing the framed clip.

12. A method of creating video content, comprising:
selecting one or more video clips based on selected criteria;
gathering and organizing the one or more video clips; and
delivering the one or more video clips to a user.

13. The method of claim 12, wherein:
the selected criteria comprises selecting videos based on historical data related to the habits of the user.

14. The method of claim 12, wherein:
the selected criteria comprises selecting videos based on a user defined interest.

15. The method of claim 14, wherein:
the user defined interest comprises a user's fantasy sports team; and
the one or more video clips comprise video clips pertaining to one or more players on the user's fantasy sports team.

16. The method of claim 12, further comprising:
adding data representative of the one or more video clips to the one or more video clips.

17. The method of claim 16, wherein:
the data representative of the one or more video clips comprises metadata.

18. The method of claim 12, wherein:
the one or more video clips are delivered to a mobile device in standard definition format.

19. The method of claim 12, wherein:
the one or more video clips are delivered to a computer device in high definition format.

20. A system for streaming content, comprising:
one or more front end components; and
one or more backend components;
wherein:
the one or more front end components are coupled to the one or more backend components via a network; and
the one or more or more backend components comprises a processing unit, a background processing unit; one or more databases; an application services unit; and one or more video components.
